(19) United States
(12) Patent Application Publication
(10) Pub. No.: US 2026/0267267 A1
(43) Pub. Date: Sep. 10, 2026

(54) IMAGE FORMING APPARATUS AND DISPLAY APPARATUS

(71) Applicant: CANON KABUSHIKI KAISHA, Tokyo (JP)

(72) Inventor: NORIAKI MATSUI, Chiba (JP)

(21) Appl. No.: 19/555,494

(22) Filed: Mar. 3, 2026

(30) Foreign Application Priority Data
Mar. 4, 2025 (JP) 2025-034032

(51) Int. Cl. G03G 15/00; G06K 15/00

(52) U.S. Cl. CPC G03G 15/5029; G03G 15/502; G03G 15/55; G03G 15/6558; G06K 15/005; G06K 15/4065; G03G 2215/00556; G03G 2215/00751

(57) ABSTRACT

An image forming apparatus includes a measuring unit, a classifying unit that classifies a recording material into one of a plurality of types using measured physical property values, an image forming unit, and a control unit. The control unit controls the image forming unit in two modes: (1) in a first control mode, image formation on a first recording material is started after its classification is completed; and (2) in a second control mode, image formation on a second recording material is started before its own classification ends, applying the classification result of the preceding first recording material.

### BACKGROUND

### Field of the Technology

The present disclosure relates to an image forming apparatus and a display apparatus.

### Description of the Related Art

Conventionally, there has been known an image forming apparatus that measures a physical property value of a recording material on a conveyance path by a sensor and selects processing to be applied to the recording material based on the measured physical property value. Japanese Patent Laid-Open No. 2022-062122 and Japanese Patent Laid-Open No. 2023-167369 disclose examples of such an image forming apparatus.

The image forming apparatus of Japanese Patent Laid-Open No. 2022-062122 measures, when a type of recording materials placed on a paper-feeding tray is unknown, a physical property value for a recording material that is fed first to determine the type of the recording material, and controls how to convey subsequently-fed recording materials depending on the determined type.

The image forming apparatus of Japanese Patent Laid-Open No. 2023-167369 pauses a recording material that is fed first at a position of a media sensor to measure a physical property value, and classifies the recording material into one of a plurality of types based on the measured physical property value. Furthermore, the image forming apparatus measures physical property values of subsequently-fed recording materials without pausing them, and considers that the type of the subsequently-fed recording materials has not changed from that of the initial recording material unless the measurement results show a significant gap from the measurement result for the initial recording material. Hence, the time required to measure the physical property values for the subsequently-fed recording materials is shortened and productivity is enhanced.

However, if only a simplified determination based on a change in measurement results of physical property values for subsequently-fed recording materials as with the case of the image forming apparatus of Japanese Patent Laid-Open No. 2023-167369 is made, there is a risk that a misrecognition of a type of the recording materials could cause conveyance failure or deterioration of print quality. Meanwhile, if classification of recording materials and control based on the results of the classification are performed by a uniform method for all of the recording materials, productivity will decrease. Among others, if a learned model that has been well-trained for various types of recording materials is used, highly-accurate classification can be performed, but it requires longer time for the classification as the number of candidate types increases.

### SUMMARY

The present disclosure is directed to provide an improved mechanism that can achieve both of highly-accurate classification of recording materials and high productivity.

One aspect of the present disclosure provides an image forming apparatus comprising: a conveyance path along which a recording material is conveyed; a measuring unit configured to measure one or more physical property values of the recording material on the conveyance path; a classifying unit configured to classify the recording material into one of a plurality of types by applying the one or more physical property values measured by the measuring unit to a classification model that includes a learned model; an image forming unit configured to form an image on the recording material based on a type into which the recording material is classified; and a control unit configured to control image formation on the recording material, wherein the control unit is configured to: control, in a first control mode, the image forming unit to start image formation on a first recording material based on a type into which the first recording material is classified after classification of the first recording material by the classifying unit has ended, and control, in a second control mode, the image forming unit to start image formation on a second recording material based on the type into which the first recording material preceding the second recording material is classified before classification of the second recording material by the classifying unit ends.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing an example of a schematic configuration of an image forming apparatus according to an embodiment.

FIG. 2 is a block diagram showing an example of a configuration of a control system of an image forming apparatus according to an embodiment.

FIG. 3 is a descriptive diagram showing an example of a configuration of a sheet database.

FIG. 4 is a descriptive diagram showing an example of a configuration of a tray setting data.

FIG. 5 is a schematic diagram showing a first example of a configuration of a media sensor.

FIG. 6 is a schematic diagram showing a second example of a configuration of a media sensor.

FIG. 7 is a descriptive diagram for describing an example of a classification model.

FIG. 8 is a descriptive diagram showing an example of a configuration of a tray setting screen.

FIG. 9 is a descriptive diagram showing an example of a configuration of an automatic detection setting screen.

FIG. 10 is a descriptive diagram showing an example of a configuration of a sheet designation screen.

FIG. 11 is a descriptive diagram showing a first example of a configuration of an abnormality notification screen.

FIG. 12 is a descriptive diagram showing a second example of a configuration of an abnormality notification screen.

FIG. 13 is a flowchart showing an example of a flow of sheet setting processing according to an embodiment.

FIG. 14 is a flowchart showing an example of a flow of conveyance control processing in a case where automatic detection is enabled according to an embodiment.

FIG. 15 is a flowchart showing an example of a more concrete flow of abnormality processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Configuration Examples of Apparatus

In the present specification, an example in which the technology according to the present disclosure is applied to an image forming apparatus 100 that forms an image by electrophotographic method is mainly described. However, the technology according to the present disclosure is not limited to this example and is applicable to an image forming apparatus that forms an image by another method such as inkjet method or offset printing method. In addition, in the following example, the image forming apparatus 100 is a so-called multifunction peripheral. However, the technology according to the present disclosure is also applicable to other types of image forming apparatuses such as printers, copiers and facsimiles.

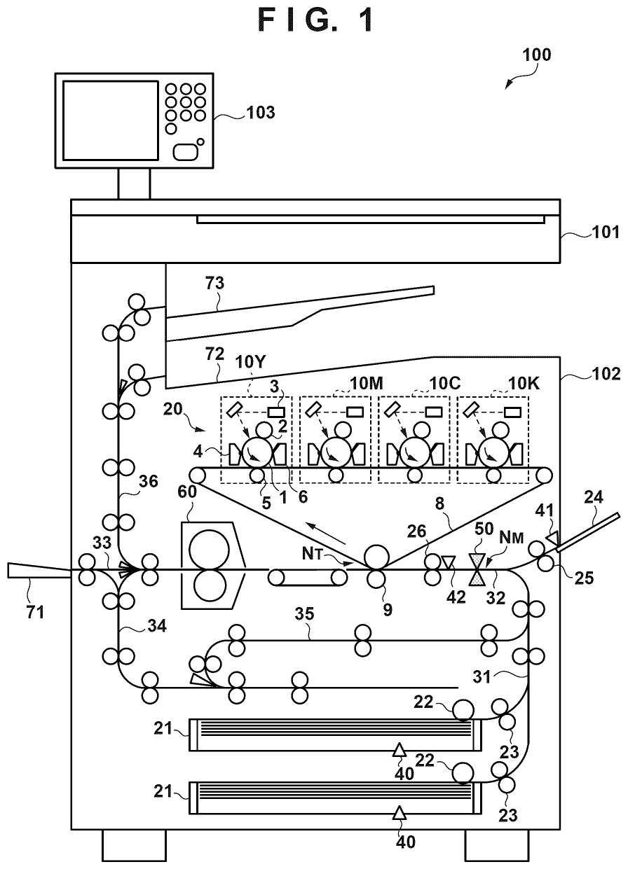

FIG. 1 is a schematic diagram showing an example of a schematic configuration of the image forming apparatus 100 according to an embodiment. With reference to FIG. 1, the image forming apparatus 100 includes a scanner unit 101, a printer unit 102, and an operation unit 103. The scanner unit 101 is a reading unit that optically reads documents in scan jobs and copy jobs. The printer unit 102 is an image forming unit that forms images on recording materials (also referred to as sheets) in print jobs and copy jobs. Note that, in the following descriptions, print jobs and copy jobs are sometimes collectively referred to as image formation jobs. The operation unit 103 includes input devices such as a touch sensor, a button and a switch and output devices such as a display and a speaker, and provides a user of the image forming apparatus 100 with user interfaces (UIs).

The printer unit 102 includes a plurality of paper-feeding trays 21 and a manual feeding tray 24. Each of the paper-feeding trays 21 contains a bundle of sheets. A sheet sensor 40 detects insertion of a paper-feeding tray 21 into the image forming apparatus 100 or placement of sheets onto a paper-feeding tray 21. A feeding roller 22 picks up a sheet from a paper-feeding tray 21 to feed it to a conveyance path 31. Separation rollers 23 separate the sheet fed by the feeding roller 22 from the bundle of sheets. The sheet is conveyed from the conveyance path 31 to a conveyance path 32 by a plurality of conveyance rollers. The manual feeding tray 24 is a tray on which a manually-supplied sheet is placed. A manual feeding sensor 41 detects placement of a sheet on the manual feeding tray 24. Manual feeding rollers 25 feed the sheet placed on the manual feeding tray 24 to the conveyance path 32.

A process unit 20 includes an intermediate transfer belt 8, a secondary transfer roller 9, and image forming units 10Y, 10M, 10C and 10K. The image forming units 10Y, 10M, 10C and 10K form toner images using development agent (also referred to as toner) of yellow, magenta, cyan and black, respectively.

As the image forming units 10Y, 10M, 10C and 10K have common configurations except for the toner colors, the image forming units 10Y, 10M, 10C and 10K are herein collectively referred to as image forming units 10, and one of the image forming units 10 is taken as an example for explanation. The image forming unit 10 has a photosensitive body 1, a charger 2, an exposure device 3, a developer 4, a primary transfer roller 5, and a drum cleaner 6.

The photosensitive body 1 is a cylindrical image carrier that is driven to rotate by a driving unit (not illustrated) such as a motor. The charger 2 is a charging unit that charges a surface of the photosensitive body 1 (for example, a charging roller or a charging wire). A charging voltage is applied to the charger 2. The exposure device 3 forms an electrostatic latent image on the surface of the photosensitive body 1 by irradiating the surface of the photosensitive body 1 with light modulated in accordance with input image data. The exposure device 3 may be an apparatus of laser exposure type that scans the surface of the photosensitive body 1 by a laser beam along a main scanning direction that is parallel to a rotation axis of the photosensitive body 1, or an apparatus of solid-state exposure type that forms an image of light from multiple light-emitting elements arranged along the main scanning direction on the surface of the photosensitive body 1. The developer 4 is a developing unit that develops the electrostatic latent image on the surface of the photosensitive body 1 by supplying toner stored in a toner container to the photosensitive body 1 to form a toner image. A developing voltage is applied to the developer 4. The developing voltage promotes adhesion of the toner to the photosensitive body 1. The photosensitive body 1 further rotates to convey the toner image to a primary transfer position. The primary transfer roller 5 is disposed so as to face the photosensitive body 1 at the primary transfer position. A primary transfer voltage is applied between the primary transfer roller 5 and the photosensitive body 1. The primary transfer roller 5 transfers the toner image from the photosensitive body 1 to the intermediate transfer belt 8. The primary transfer voltage promotes the primary transfer of the toner image. The drum cleaner 6 removes toner that remains on the photosensitive body 1.

The image forming units 10Y, 10M, 10C and 10K transfer toner images of respective colors to the intermediate transfer belt 8 in an overlapping manner. In this way, a full color toner image is formed on the intermediate transfer belt 8. The intermediate transfer belt 8 carries the toner image to convey it to a secondary transfer position N_{T}.

A registration sensor 42 detects a sheet accepted into the conveyance path 32. Registration rollers 26 send the sheet to the secondary transfer position N_{T} in synchronization with the timing at which the toner image carried by the intermediate transfer belt 8 arrives at the secondary transfer position N_{T}.

The secondary transfer roller 9 rotates while sandwiching the sheet together with the intermediate transfer belt 8 at the secondary transfer position N_{T}. The secondary transfer roller 9, to which a secondary transfer voltage is applied, transfers the toner image on the intermediate transfer belt 8 to the sheet. The sheet having the toner image transferred thereon is conveyed toward a fixing unit 60.

The fixing unit 60 heats and pressurizes the sheet, thereby melting the toner to fix the toner image to the sheet. When double-sided printing is designated, the sheet of which a first surface has a toner image formed thereon is guided from a conveyance path 34 to a conveyance path 35, and passes through the secondary transfer position N_{T} again having been flipped front to back. The secondary transfer roller 9 transfers a toner image to a second surface of the sheet. The sheet passes through the fixing unit 60 again, and the fixing unit 60 fixes the toner image on the second surface to the sheet. The sheet that has passed through the fixing unit 60 is discharged via a conveyance path 33 to a discharge tray 71, or via a conveyance path 36 to a discharge tray 72 or 73.

In the above-described image forming operation, a charging voltage, a light amount of exposure, a developing voltage, a primary transfer voltage, a secondary transfer voltage, a fixing temperature, and a conveyance speed of sheets (also referred to as a process speed) are examples of image formation conditions. The image formation conditions are selected depending on a type of a sheet. For determining types of sheets, in the present embodiment, the printer unit 102 has a media sensor 50 as a measuring unit to measure one or more physical property values of a sheet on the conveyance path 32. The media sensor 50 is disposed at a measurement position N_{M} that is upstream from the transfer position N_{T} at which an image is transferred to a sheet. Although one media sensor 50 is illustrated in FIG. 1, the printer unit 102 may have a plurality of sensors that measure physical property values that are different from each other. Classification of sheets based on measurement of physical property values by the media sensor 50 will be described in detail below.

### 2. Configuration Examples of Control System

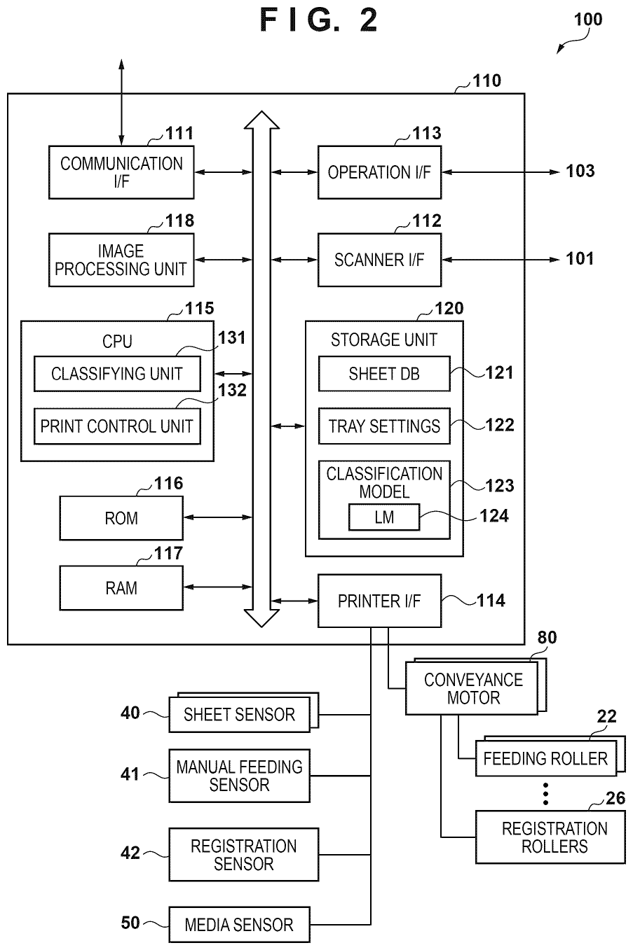

FIG. 2 is a block diagram illustrating an example of a configuration of a control system of the image forming apparatus 100. With reference to FIG. 2, the image forming apparatus 100 has a controller 110. The controller 110 includes a communication interface (I/F) 111, a scanner I/F 112, an operation I/F 113, a printer I/F 114, a CPU 115, a ROM 116, a RAM 117, an image processing unit 118, and a storage unit 120.

The communication I/F 111 is an interface for the image forming apparatus 100 to communicate with external apparatuses. The communication I/F 111 may be a wireless communication interface or may be a wired communication interface. The functions of the controller 110 described below may be provided by a host computer that communicates with the image forming apparatus 100 via the communication I/F 111.

The scanner I/F 112 is an interface for connecting the controller 110 to the scanner unit 101. The operation I/F 113 is an interface for connecting the controller 110 to the operation unit 103. The printer I/F 114 is an interface for connecting the controller 110 to numerous sensors and actuators of the printer unit 102. FIG. 2 shows the sheet sensors 40, the manual feeding sensor 41, the registration sensor 42, and the media sensor 50, but the printer unit 102 may have further sensors that are not illustrated. In addition, FIG. 2 shows a plurality of conveyance motors 80 as examples of the actuators of the printer unit 102. For example, one conveyance motor 80 causes a feeding roller 22 to rotate, and another conveyance motor causes the registration rollers 26 to rotate.

The central processing unit (CPU) 115 is a control unit that controls overall operations of the image forming apparatus 100. The read-only memory 116 is a non-volatile storage medium and stores in advance computer programs for control functions of the image forming apparatus 100. The random access memory (RAM) 117 is a volatile storage medium and provides the CPU 115 with storage regions for computation. The CPU 115 controls the operations of the image forming apparatus 100 by executing the computer programs loaded from the ROM 116 to the RAM 117. For example, the CPU 115 controls the printer unit 102 to form an image based on input image data received from an external apparatus in a print job. The CPU 115 also controls the printer unit 102 to form an image based on read image data generated by the scanner unit 101 in a copy job. The image processing unit 118 performs image processing for adapting input image data of print jobs and read image data of copy jobs to a format suitable for image formation in the printer unit 102. The image processing performed by the image processing unit 118 may include, for example, one or more of image rotation, resizing, noise removal, rasterization, tone conversion, color conversion, and binarization.

In the present embodiment, the CPU 115 functions as a classifying unit 131 and a print control unit 132. The classifying unit 131 classifies a sheet into one of a plurality of types by applying a physical property value measured for the sheet to a classification model 123 described below. The print control unit 132 controls conveyance of sheets and image formation on the sheets in the printer unit 102. The sheet classification by the classifying unit 131 and the print control by the print control unit 132 are described in detail below.

The storage unit 120 is a storage device that has a large capacity storage region such as a hard disk drive (HDD) or a solid-state drive (SSD), for example. In the present embodiment, the storage unit 120 stores a sheet database (DB) 121, tray setting data 122, and the classification model 123. The sheet DB 121 is a database that maintains image formation conditions suitable for each type of sheet in association with the type of sheet. The tray setting data 122 is data indicating settings for the type of sheet contained in or placed on each of the paper-feeding trays 21 and the manual feeding tray 24.

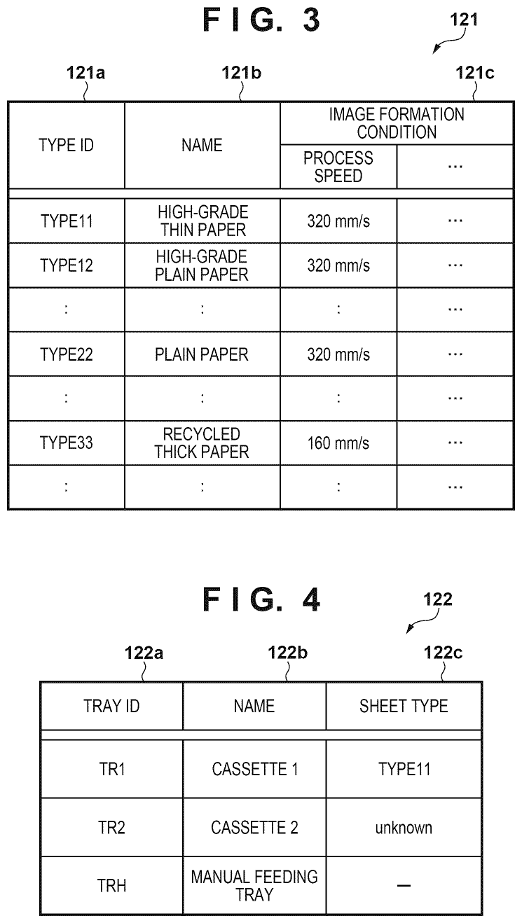

FIG. 3 is a descriptive diagram showing an example of a configuration of the sheet DB 121. With reference to FIG. 3, the sheet DB 121 includes TYPE ID 121a, NAME 121b, and IMAGE FORMATION CONDITION 121c. TYPE ID 121a is identification information for uniquely identifying a type of sheet. NAME 121b is a name given to each type. The name of each type may be, for example, a generic name such as “plain paper” and “thick paper”, or may be a manufacturer-specific brand name. IMAGE FORMATION CONDITION 121c is data indicating image formation conditions suitable for each type of sheet. IMAGE FORMATION CONDITION 121c indicates, for each type of sheet, values of one or more of a charging voltage, a light amount, a developing voltage, a primary transfer voltage, a secondary transfer voltage, a fixing temperature, and a process speed, for example (parameter values other than the process speed are omitted in FIG. 3).

FIG. 4 is a descriptive diagram showing an example of a configuration of the tray setting data 122. With reference to FIG. 4, the tray setting data 122 includes TRAY ID 122a, NAME 122b, and SHEET TYPE 122c. TRAY ID 122a is identification information for uniquely identifying each of the paper-feeding trays 21 and the manual feeding tray 24. NAME 122b is a name given to each tray. SHEET TYPE 122c indicates a setting for a type of sheet contained in or placed on each tray. In the example of FIG. 4, a first paper-feeding tray 21 identified by the tray ID “TR1” contains sheets of the type “HIGH-GRADE THIN PAPER”, and SHEET TYPE 122c of the corresponding record indicates the type ID “TYPE11” identifying that type. The type of sheet contained in a second paper-feeding tray 21 identified by the tray ID “TR2” is unknown, and SHEET TYPE 122c of the corresponding record indicates ‘unknown’. Regarding the manual feeding tray 24 identified by the tray ID “TRH”, the type of sheet is assumed to be automatically detected during job execution, and SHEET TYPE 122c of the corresponding record is blank.

It should be noted that the data described as being maintained in the storage unit 120 of the image forming apparatus 100 in the present embodiment may be maintained by a database external to the image forming apparatus 100 (for example, a database server on the network) in another embodiment.

### 3. Measurement of Physical Property Values and Classification of Sheets

The classification model 123 is a predetermined computation model for classifying a sheet into one of a plurality of types based on one or more physical property values measured for the sheet. In the present embodiment, the classification model 123 includes a learned model 124 that has been acquired in advance through machine learning based on samples of a plurality of types of sheets and known physical property values for those samples. The classification model 123 may be the learned model 124 as a whole, or may be a combination of the learned model 124 and a non-learning-based logic (for example, simple comparison between a physical property value and a threshold).

The physical property values used for the sheet classification can include, for example, at least one of the following:
a physical property value related to surface property of a sheet;
a physical property value related to grammage of a sheet;
a physical property value related to thickness of a sheet;
a physical property value related to rigidity level of a sheet;
a physical property value related to volume resistivity of a sheet; and
a physical property value related to moisture content of a sheet.

Sensors for measuring these physical property values may have any configurations known in this technical field. Herein, measurements of physical property values related to surface property and grammage are described.

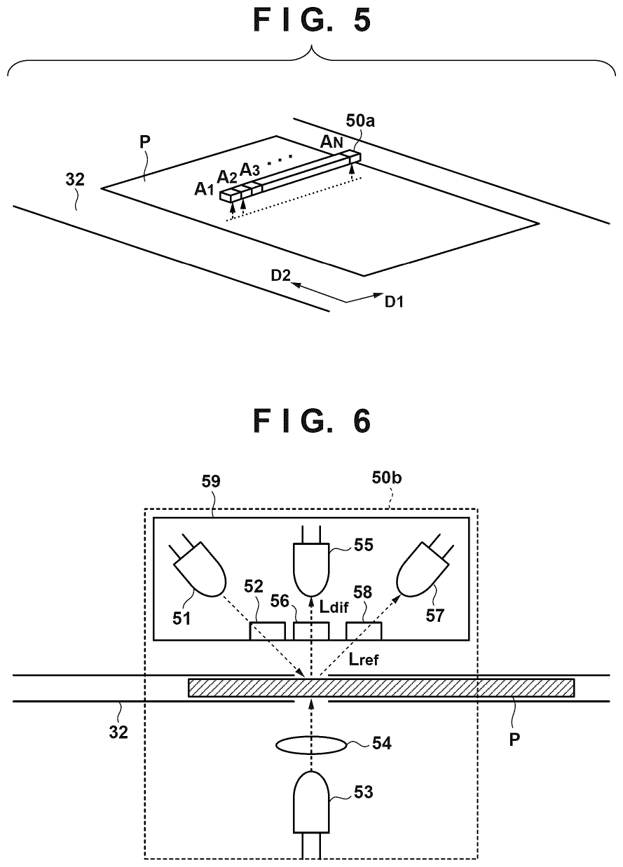

FIG. 5 is a schematic diagram showing a first example of a configuration of a media sensor. A media sensor 50a illustrated in FIG. 5 is a so-called optical line sensor (for example, a contact image sensor (CIS)), and includes N light-receiving elements A₁ to A_{N} arranged in series along a line that is parallel to the main scanning direction D1. The light-receiving elements A₁ to A_{N} measure, for one measurement operation, luminance at respective pixel positions on a corresponding line of a sheet P conveyed along a sub-scanning direction D2 on the conveyance path 32. The media sensor 50a repeats the measurement operation M times while the sheet P is conveyed. In this way, measurement results consisting of M×N luminance values L_{m,n} (1≤m≤M, 1≤n≤N) can be obtained for one sheet P. The measurement results are accumulated in a RAM within the media sensor 50a, for example. The media sensor 50a calculates a sum of neighboring pixel differences L_{SUM_m} of an m-th line based on the measured luminance values L_{m,n} in accordance with the following formula (1):

$${L}_{S U {M}_{- m}} = {\sum }_{n = 1}^{N - 1} \vert {L}_{m , n + 1} - {L}_{m , n} \vert \qquad ( 1 )$$

Furthermore, the media sensor 50a may calculate a total sum of neighboring pixel differences L_{SUM} of the sheet P in accordance with the following formula (2):

$${L}_{S U M} = {\sum }_{m = 1}^{M} {L}_{S U {M}_{- m}} \qquad ( 2 )$$

Using the total sum of neighboring pixel differences calculated from the measurement results of multiple lines of one sheet P as a physical property value for surface property can mitigate a bias in results of measurement that depends on the measurement position.

In addition, the media sensor 50a may calculate a brightness B of the sheet P in accordance with the following formula (3):

$$B = {\sum }_{m = 1}^{M} {\sum }_{n = 1}^{N} {L}_{m , n} \qquad ( 3 )$$

The brightness B is equal to the total sum of the luminance values measured by the N light-receiving elements A₁ to A_{N} and correlates with a reflectance of the sheet P.

For example, a transparent film made of resin such as polyethylene terephthalate (PET) has a small reflectance and thus exhibits a low brightness. Embossed paper having geometric unevenness on its surface exhibits a large sum of neighboring pixel differences because the unevenness causes differences in luminance among neighboring pixels. Coated paper having a coating layer with less unevenness on its surface exhibits a small sum of neighboring pixel differences. Recycled paper having short pulp fiber as a result of several recycling processes and non-uniform texture directions exhibits a relatively large sum of neighboring pixel differences. Hence, the sum of neighboring pixel differences, the total sum of neighboring pixel differences and the brightness described above measured by the media sensor 50a can be used as physical property values representing surface property of a sheet to classify the sheet.

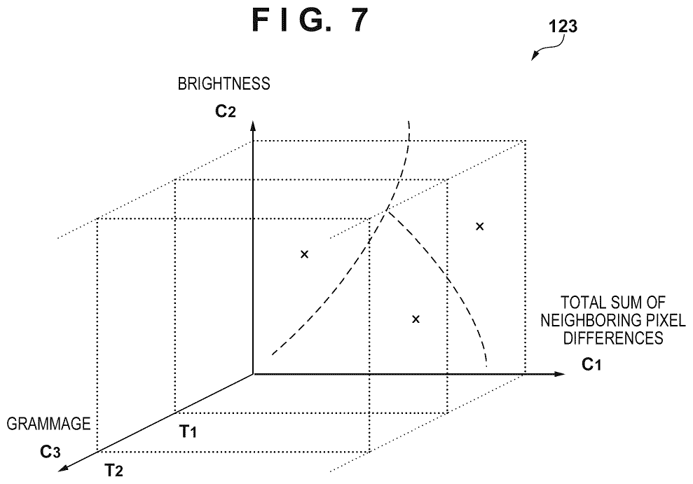

FIG. 6 is a schematic diagram showing a second example of a configuration of a media sensor. A media sensor 50b illustrated in FIG. 6 includes a first light-emitting element 51, a first slit 52, a second light-emitting element 53, a guide 54, a first light-receiving element 55, a second slit 56, a second light-receiving element 57, and a third slit 58. The first light-emitting element 51, the first light-receiving element 55 and the second light-receiving element 57 are contained in a main unit 59 disposed on one side of the conveyance path 32. The second light-emitting element 53 and the guide 54 are disposed on the opposite side of the conveyance path 32 from the main unit 59.

The first light-emitting element 51 and the second light-emitting element 53 may be light-emitting diodes (LEDs), for example. The first light-receiving element 55 and the second light-receiving element 57 may be phototransistors, for example. The first light-emitting element 51 irradiates a sheet P conveyed along the conveyance path 32 with light via the first slit 52 with a predetermined output light amount and a predetermined incident angle. The first light-receiving element 55 receives, via the second slit 56, a part of the light diffusely reflected at a surface of the sheet P. The second light-receiving element 57 receives, via the third slit 58, the light specularly reflected at the surface of the sheet P. When the received light amount of the diffusely-reflected light at the first light-receiving element 55 is denoted by L_{dif} and the received light amount of the specularly-reflected light at the second light-receiving element 57 is denoted by L_{ref}, smoothness x as one of the physical property values related to surface property of the sheet P can be calculated using the following formula (4):

$$x = \frac{{L}_{r e f}}{{L}_{d i f}} \qquad ( 4 )$$

The larger the value x, the greater the light amount of specularly-reflected light relative to the light amount of diffusely-reflected light, and the smoother the surface of the sheet P.

The second light-emitting element 53 irradiates the sheet P conveyed along the conveyance path 32 with light from the opposite side from the main unit 59 via the guide 54 with a predetermined output light amount. A part of the emitted light passes through the sheet P and is received by the first light-receiving element 55 via the second slit 56. A proportion of the received light amount at the first light-receiving element 55 to the output light amount of the second light-emitting element 53 is referred to as transmittance of the sheet P. The transmittance of the sheet P is one of the physical property values related to grammage or thickness of the sheet P. The larger the grammage or the thickness of the sheet P, the smaller the transmittance. It should be noted that the transmittance can also be measured using light such as visible light or infrared light, or may be measured using ultrasonic waves.

FIG. 7 is a descriptive diagram for describing an example of a classification model that is based on physical property values measured using one or both of the media sensors 50a and 50b. FIG. 7 illustrates a three-dimensional vector space constituted by the elements of the total sum of neighboring pixel differences C₁, the brightness C₂ and the grammage C₃. A measurement result for one sheet corresponds to a single point in the vector space. Herein, the classification model 123 is a combination of classification related to surface property to three types based on discrimination lines on C₁-C₂ plane indicated by broken lines and classification related to grammage to three types based on grammage thresholds T₁, T₂ plotted on C₃ axis. The discrimination lines on C₁-C₂ plane are predetermined through machine learning in advance and maintained by the learned model 124. The grammage thresholds T₁, T₂ on C₃ axis are predetermined from non-learning-based knowledge.

The classifying unit 131 classifies a sheet P into any one of “SMOOTH”, “STANDARD” and “ROUGH” in accordance with the discrimination lines by applying the total sum of neighboring pixel differences C₁ and the brightness C₂ measured for the sheet P to the learned model 124. In addition, the classifying unit 131 classifies the sheet P into any one of “THIN”, “PLAIN” and “THICK” by comparing the grammage C₃ measured for the sheet P with the grammage thresholds T₁ and T₂. The classifying unit 131 can classify the sheet P into one of the following nine types by combining these results of classification:
“SMOOTH” and “THIN”=“HIGH-GRADE THIN PAPER”;
“SMOOTH” and “PLAIN”=“HIGH-GRADE PLAIN PAPER”;
“SMOOTH” and “THICK”=“HIGH-GRADE THICK PAPER”;
“STANDARD” and “THIN”=“THIN PAPER”;
“STANDARD” and “PLAIN”=“PLAIN PAPER”;
“STANDARD” and “THICK”=“THICK PAPER”;
“ROUGH” and “THIN”=“RECYCLED THIN PAPER”;
“ROUGH” and “PLAIN”=“RECYCLED PLAIN PAPER”; and
“ROUGH” and “THICK”=“RECYCLED THICK PAPER”.

It should be noted that the classification model 123 described above is a mere example of a model for classifying a sheet based on physical property values of the sheet. The classification model 123 may receive a larger number of physical property values as inputs. Moreover, the classification model 123 may use more discrimination lines and more thresholds to classify sheets to an even wider variety of types.

### 4. Multiple Control Modes

As the number of candidates of sheet types handled by the classification model 123 increases, classification processing will require more time. If the classifying unit 131 performs classification for all of the sheets and images are formed on the sheets under image formation conditions selected based on the classification results, standby time until the end of the classification processing would reduce job productivity. Meanwhile, if the classification processing is performed only for the initial sheet and the classification processing is omitted for the subsequently-fed sheets, there would be a risk that misrecognition of a type causes conveyance failure or deterioration of print quality. Accordingly, in the present embodiment, the print control unit 132 causes the classifying unit 131 to perform classification processing for all of the sheets but causes image forming operation to be started without waiting for the end of the classification processing for the sheets to which a classification result in the past can be analogically applied.

More specifically, the print control unit 132 selects a first control mode and a second control mode described as follows for a first sheet (first recording material) and a second sheet (second recording material), respectively. In the first control mode, the print control unit 132 controls the printer unit 102 to start image formation on the first sheet based on the type into which the first sheet is classified after the classification of the first sheet by the classifying unit 131 has ended. In the second control mode, the print control unit 132 controls the printer unit 102 to start image formation on the second sheet based on the type into which the first sheet preceding the second sheet is classified before the classification of the second sheet by the classifying unit 131 ends.

There is also a difference between the first control mode and the second control mode in the timings at which the registration rollers 26 send sheets to the secondary transfer position N_{T}. Specifically, the print control unit 132 controls, in the first control mode, the registration rollers 26 to convey the first sheet toward the secondary transfer position N_{T} after the classification of the first sheet by the classifying unit 131 has ended. The print control unit 132 controls, in the second control mode, the registration rollers 26 to convey the second sheet toward the secondary transfer position N_{T} regardless of whether the classification of the second sheet by the classifying unit 131 has ended or not.

In any of the control modes, typically, the print control unit 132 temporarily pauses a sheet that has passed through the measurement position N_{M} and reached the registration rollers 26. The print control unit 132 causes the registration rollers 26 to resume conveyance of the sheet to send the sheet to the secondary transfer position N_{T} after absorbing variation in the conveyance timing for each sheet. However, in the present embodiment, conveyance of the first sheet is paused for a first duration in the first control mode, and the classification of the first sheet by the classifying unit 131 ends during the first duration. Meanwhile, conveyance of the second sheet is paused for a second duration in the second control mode, and the second duration is shorter than the first duration. Whether classification of the second sheet by the classifying unit 131 ends during the second duration or not depends on a particular situation.

Some variations are contemplated regarding to which second sheets the classification result for the first sheet in the past can be analogically applied. In an example, the first sheet is an initial sheet after starting or (temporarily pausing for a certain reason and then) resuming an image formation job for forming images on a plurality of sheets, and the second sheet(s) are sheet(s) following the first sheet in the same image formation job. In another example, the first sheet is an initial sheet that is fed from a tray on which an unknown type of sheet are placed, and the second sheet(s) are sheet(s) fed from the same tray other than the initial sheet. For example, if the type of sheet contained in a paper-feeding tray 21 has already been known and then an operation to draw the paper-feeding tray 21 from the housing is detected, the status of the sheets in the paper-feeding tray 21 may be reset to ‘unknown’. Which one of the first control mode and the second control mode to select for each sheet may be determined in accordance with a user setting accepted in advance, for example. UIs for such a user setting will be described below.

Typically, in the second control mode, the printer unit 102 forms an image on a second sheet under image formation conditions obtained from the sheet DB 121 depending on the type into which the first sheet has been classified by the classifying unit 131. The process unit 20 starts an image forming operation for forming a toner image for the second sheet such as charging, exposure, development, and transfer without waiting for the end of classification processing for the second sheet. After the classifying unit 131 ends the classification processing for the second sheet, the print control unit 132 determines whether the type of the second sheet matches the type of the first sheet. In a case where the type of the second sheet matches the type of the first sheet, the image forming operation that has been already started is continued. In a case where the type of the second sheet is different from the type of the first sheet, the print control unit 132 applies abnormality processing for the second sheet.

The abnormality processing may include stopping conveyance of the second sheet. In a case where the second sheet is an abnormal sheet that might cause a conveyance failure, urgently stopping the conveyance can prevent a malfunction such as damage to the apparatus due to the conveyance failure or the like. The abnormality processing may include discharging the second sheet to a second discharge destination that is different from a first discharge destination to which the second sheet would be discharged in a case where the type of the second sheet matches the type of the first sheet (that is, to an escape tray that is different from a normal discharge destination). In this manner, mixture of an abnormal sheet in normal sheets on a discharge tray is avoided. The abnormality processing may include interrupting image formation by the printer unit 102 on the second sheet. In this manner, it is possible to avoid image formation under inappropriate image formation conditions to suppress waste of toner. The abnormality processing may include notifying a user of the abnormality for the type of the second sheet. In this manner, it is possible to encourage the user to quickly take a countermeasure such as checking the tray from which the sheet is supplied or the like.

The above embodiments for the abnormality processing may be combined with each other in any way. The print control unit 132 may perform variable abnormality processing depending on the type into which the second sheet is classified. For example, while the print control unit 132 stops conveyance of the second sheet that has been classified into a type which might cause a conveyance failure, it may discharge the other abnormal sheets to the escape tray. In this manner, it is possible to suppress the number of times a user is required to perform an elimination work for a jam due to an urgent stop.

It should be noted that, as a third control mode that is different from the first control mode and the second control mode, there may exist a mode in which a user designates a type of sheet. The type of sheet may be designated in a fixed manner irrespective of a tray operation, or may be designated on a screen by a user whenever a tray operation is detected (for example, a paper-feeding tray 21 has been drawn out, or a sheet has been placed on the manual feeding tray 24). In a case where a user designates a type of sheet, the print control unit 132 may or may not cause the classifying unit 131 to perform sheet classification. In an example where the sheet classification is performed, the print control unit 132 may trigger an operation to form an image on a sheet before the classification processing ends. The printer unit 102 forms an image on a sheet under image formation conditions corresponding to the type of the sheet designated by the user. The print control unit 132 may apply abnormality processing that is similar to that in the second control mode when the type of the sheet determined as a result of the classification processing is different from the type designated by the user.

### 5. Examples of User Interfaces

### <5-1. Settings Per Tray>

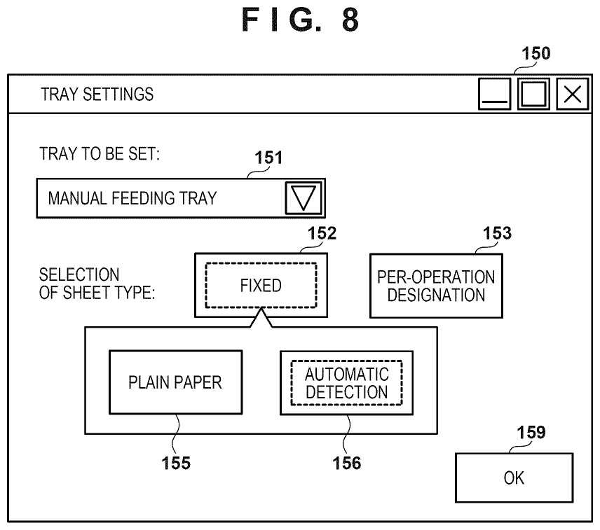

In this section, some UI configuration examples for settings related to sheet classification will be described using FIGS. 8 to 10.

FIG. 8 is a descriptive diagram showing an example of a configuration of a tray setting screen 150. For example, when a predetermined operation is performed on a menu screen (not shown) displayed on a display of the operation unit 103, the menu screen may be transitioned to the tray setting screen 150. The tray setting screen 150 includes a tray selection field 151, a fixed-selection button 152, a per-operation designation button 153, a sheet type selection button 155, an automatic detection button 156, and an OK button 159.

The tray selection field 151 is an object for accepting a selection of a tray that is a target of the settings (for example, a pull-down menu). In the example of FIG. 8, the manual feeding tray 24 has been selected as the target of the settings.

The fixed-selection button 152 is a button for setting, in a fixed manner (that is, in common for a plurality of image formation jobs), a mode to determine a type of sheet for the tray selected in the tray selection field 151. When the fixed-selection button 152 is operated, the sheet type selection button 155 and the automatic detection button 156 are displayed.

The sheet type selection button 155 is a button for the user to designate a type of sheet. When the sheet type selection button 155 is operated, options of types of sheets that are similar to those in a sheet designation screen 170 described below are presented to the user, and a selection of one of the options is accepted. In the example of FIG. 8, “PLAIN PAPER” has been selected.

The automatic detection button 156 is a button for enabling automatic detection of a type of sheet. When the automatic detection button 156 is operated, an automatic detection setting screen 160 described below is displayed, and more detailed settings for automatic detection will be accepted. When automatic detection is enabled, the conveyance control in the first control mode and the second control mode described above is carried out during execution of an image formation job.

The per-operation designation button 153 is a button for setting the image forming apparatus 100 to cause a user to designate a mode to determine a type of sheet for the tray selected in the tray selection field 151 whenever an operation of the tray is detected.

The OK button 159 is a button for finalizing the change of the settings on the tray setting screen 150 and closing the tray setting screen 150.

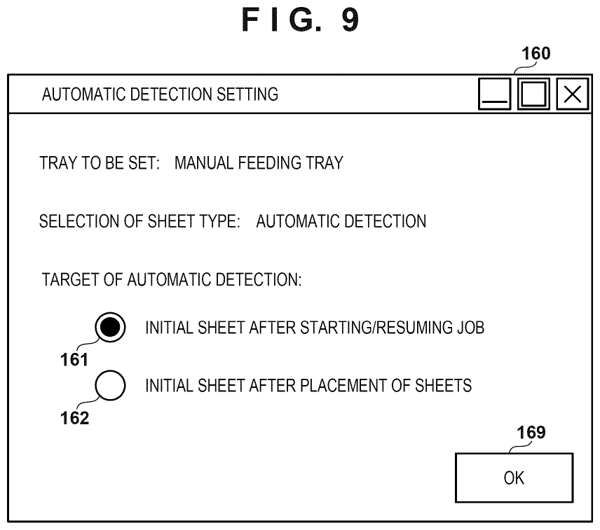

FIG. 9 is a descriptive diagram showing an example of a configuration of the automatic detection setting screen 160. As described above, when the automatic detection button 156 is operated on the tray setting screen 150, the tray setting screen 150 may be transitioned to the automatic detection setting screen 160. The automatic detection setting screen 160 includes radio buttons 161 and 162, and an OK button 169.

The radio buttons 161 and 162 are objects for the user to select a mode regarding to which subsequent sheets a classification result for a preceding sheet is applied. For example, when the radio button 161 is selected, an initial sheet after starting or resuming an image formation job for forming images on a plurality of sheets is treated as a first sheet, and the first control mode is applied to the first sheet. Then, sheets following the first sheet are treated as second sheets in the same image formation job, and the second control mode is applied to the second sheets. On the other hand, when the radio button 162 is selected, an initial sheet fed from a tray on which an unknown type of sheet are placed is treated as a first sheet, and the first control mode is applied to the first sheet. Then, sheets conveyed afterward are treated as second sheets irrespective of whether they are in the same image formation job or in a different image formation job, and the second control mode is applied to the second sheets.

The OK button 169 is a button for finalizing the detailed settings of automatic detection on the automatic detection setting screen 160 and going back to the tray setting screen 150.

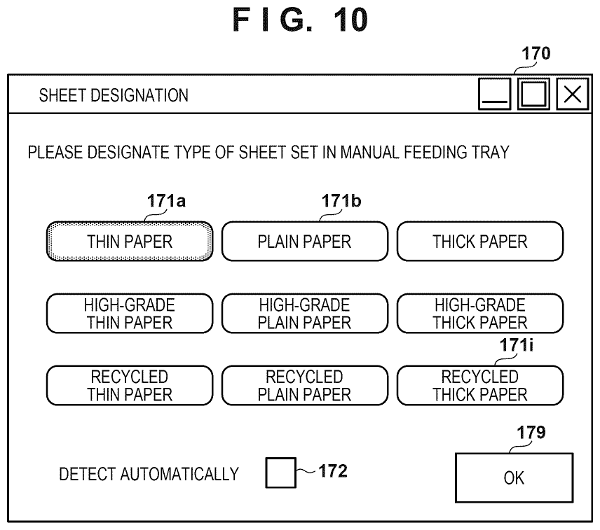

FIG. 10 is a descriptive diagram showing an example of a configuration of the sheet designation screen 170. The sheet designation screen 170 may be displayed on the display of the operation unit 103 when a tray operation is detected in a state where a setting for the user to designate a type of sheet whenever a tray operation is detected has been registered in advance on the tray setting screen 150. The sheet designation screen 170 includes nine sheet type selection buttons 171a, 171b, . . . , 171i, a checkbox 172, and an OK button 179.

The sheet type selection buttons 171a, 171b, . . . , 171i are buttons respectively corresponding to the options for a type of sheet. In the example of FIG. 10, as a result of the sheet type selection button 171a having been operated, the sheet type selection button 171a is displayed in an emphasized manner, and “THIN PAPER” is designated as the type of sheet.

The checkbox 172 is an object for enabling automatic detection of a type of sheet. When the checkbox 172 is turned ON, automatic detection of a type of sheet is enabled for an upcoming image formation job. The designation of a type of sheet through the sheet type selection buttons 171a, 171b, . . . , 171i is canceled.

The OK button 179 is a button for finalizing the designation of a type of sheet on the sheet designation screen 170 (or enablement of automatic detection) and closing the sheet designation screen 170.

### <5-2. Abnormality Notification>

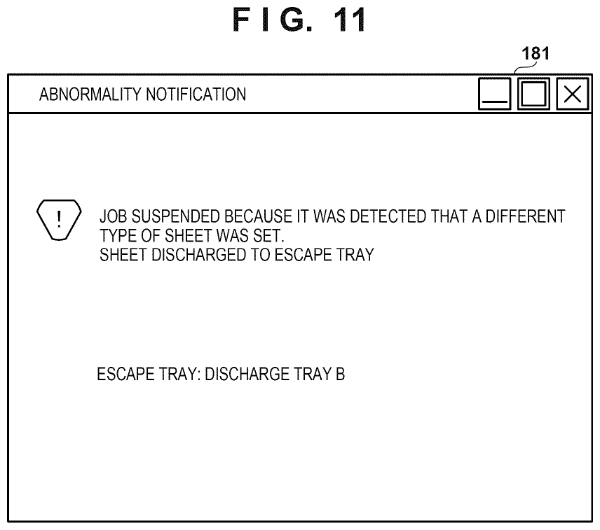

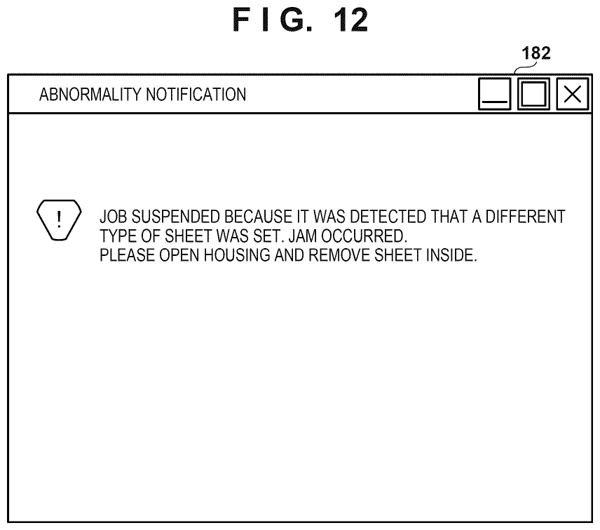

In this section, UI configuration examples that may be displayed when an abnormality of a type of sheet has been detected in an image formation job for which automatic detection of a type of sheet is enabled will be described using FIGS. 11 and 12.

FIG. 11 is a descriptive diagram showing a first example of a configuration of an abnormality notification screen. In the first example, in a case where a type of a second sheet classified by the classifying unit 131 is different from the type of the first sheet, the print control unit 132 suspends image formation on the second sheet by the printer unit 102, and causes the second sheet to be discharged to the escape tray. Then, the print control unit 132 causes the display of the operation unit 103 to display an abnormality notification screen 181. The abnormality notification screen 181 includes messages indicating that the image formation job has been suspended because there is an abnormal type of sheet placed on the tray from which sheets are supplied and that the sheet determined to be abnormal has been discharged to the escape tray. The abnormality notification screen 181 further includes information indicating which one of the plurality of discharge trays is the escape tray. The user who saw the abnormality notification screen 181 may replace the sheets with normal ones on the tray from which sheets are supplied and resume the image formation job.

FIG. 12 is a descriptive diagram showing a second example of a configuration of an abnormality notification screen. In the second example, in a case where a type of a second sheet classified by the classifying unit 131 is different from the type of the first sheet, the print control unit 132 suspends image formation on the second sheet by the printer unit 102, and urgently stops conveyance of the second sheet. Then, the print control unit 132 causes the display of the operation unit 103 to display an abnormality notification screen 182. The abnormality notification screen 182 includes messages indicating that the image formation job has been suspended because there is an abnormal type of sheet placed on the tray from which sheets are supplied and that the sheet remaining in the housing due to the stop of conveyance of the sheet needs to be removed. The user who saw the abnormality notification screen 182 may open the housing of the image forming apparatus 100, remove the sheet that has caused the jam, replace the sheets on the tray from which sheets are supplied with normal ones, and resume the image formation job.

### 6. Examples of Flows of Processing

### <6-1. Sheet Setting Processing>

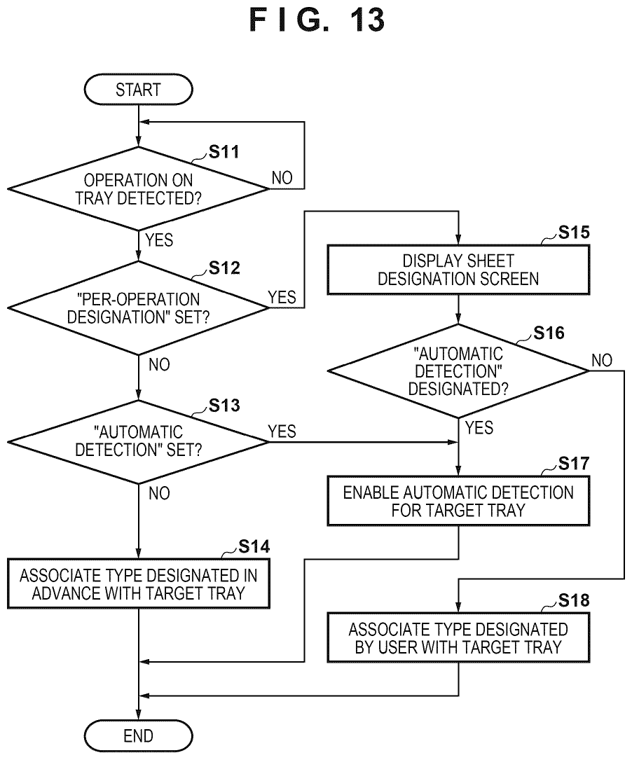

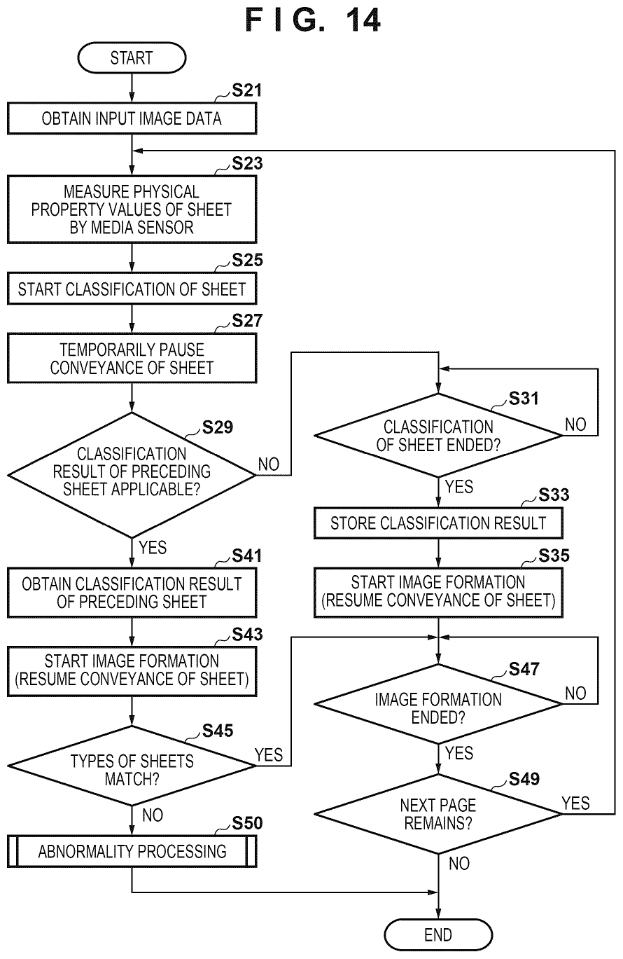

FIG. 13 is a flowchart showing an example of a flow of sheet setting processing that may be performed by the image forming apparatus 100 in the present embodiment. In the following descriptions, ‘S’ is an abbreviation of a processing step.

First, in S11, the print control unit 132 steadily monitors sensor signals from the sheet sensors 40 and the manual feeding sensor 41, and waits for an operation on the paper-feeding trays 21 and the manual feeding tray 24. When a sheet sensor 40 detects placement of new sheets on a paper-feeding tray 21, or the manual feeding sensor 41 detects placement of a sheet on the manual feeding tray 24, the sheet setting processing proceeds to S12.

In S12 and S13, the sheet setting processing branches depending on settings accepted in advance for the tray operated in S11 (hereinafter, referred to as a target tray). For example, in a case where a mode to cause a user to designate a type of sheet each time has been set for the target tray (S12—YES), the sheet setting processing proceeds to S15. In a case where automatic detection of a type of sheet has been set in a fixed manner for the target tray (S12—NO, S13—YES), the sheet setting processing proceeds to S17. In a case where a type of sheet has been designated by a user in advance for the target tray (S12—NO, S13—NO), the sheet setting processing proceeds to S14.

In S14, the print control unit 132 associates the type of sheet designated in advance on the tray setting screen 150 with the target tray in the tray setting data 122. Thereafter, when an image formation job is triggered with the target tray designated as a supply source of sheets, images are formed on the sheets supplied from the target tray under image formation conditions corresponding to the type of the sheets designated in advance.

In S15, the print control unit 132 causes the sheet designation screen 170 described using FIG. 10 to be displayed on the display of the operation unit 103. In S16, the sheet setting processing branches depending on a user input accepted on the sheet designation screen 170. For example, in a case where automatic detection of a type of sheet is designated by an operation on the checkbox 172, the sheet setting processing proceeds to S17. On the other hand, in a case where a specific type of sheet is designated by the user instead of automatic detection being designated, the processing proceeds to S18.

In S17, the print control unit 132 enables automatic detection of a type of sheet for the target tray. Thereafter, when an image formation job is triggered with the target tray designated as a supply source of sheets, the sheets are conveyed in accordance with conveyance control processing described below, and a type of the sheets is automatically detected.

Meanwhile, in S18, the print control unit 132 associates the type of sheet designated on the sheet designation screen 170 with the target tray in the tray setting data 122. Thereafter, when an image formation job is triggered with the target tray designated as a supply source of sheets, images are formed on the sheets supplied from the target tray under image formation conditions corresponding to the type of the sheets designated in S16.

### <6-2. Conveyance Control Processing>

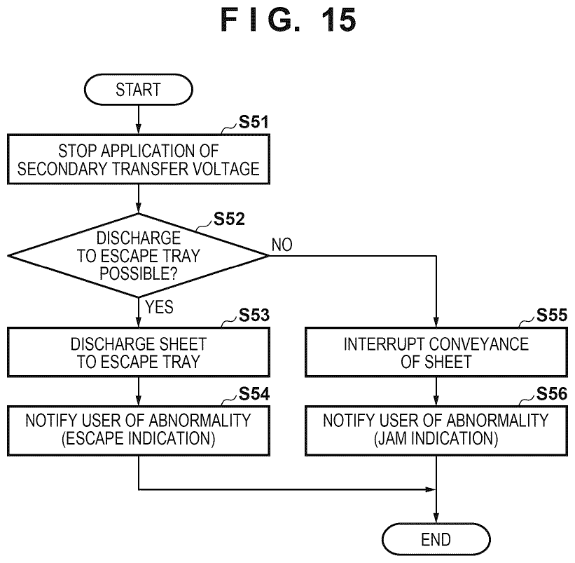

FIG. 14 is a flowchart showing an example of a flow of conveyance control processing in a case where automatic detection is enabled in the present embodiment.

The conveyance control processing of FIG. 14 starts in S21 with the print control unit 132 obtaining input image data of an image formation job. The input image data is converted, by the image processing unit 118, into a suitable form for image formation by the printer unit 102. The print control unit 132 sequentially sends the sheets from the tray designated by the user to the conveyance path 32. The processing steps in and after S23 are iterated for each sheet.

In S23, the media sensor 50 measures one or more physical property values of a sheet on the conveyance path 32. Next, in S25, the classifying unit 131 starts classification of the sheet based on the physical property values measured by the media sensor 50. In the classification processing here, the classifying unit 131 applies the one or more physical property values of the sheet to the classification model 123. Next, in S27, the print control unit 132 temporarily pauses conveyance of the sheet that has passed through the measurement position N_{M}.

The subsequent conveyance control processing branches in S29 depending on whether the classification result of the preceding sheet is applicable to the sheet being conveyed or not. In a case where the sheet being conveyed is an initial sheet after starting or resuming the image formation job or an initial sheet fed from a tray on which an unknown type of sheet are placed, no classification result of a preceding sheet is applicable and thus the conveyance control processing proceeds to S31. In this case, the first control mode is selected and the sheet being conveyed is treated as the first sheet. In a case where the sheet being conveyed is a second sheet following the first sheet, the conveyance control processing proceeds to S41. In this case, the second control mode is selected and the classification result of the preceding sheet (that is, the first sheet) is applied to the second sheet.

In S31, the print control unit 132 waits for the end of classification of the first sheet by the classifying unit 131. After the classifying unit 131 ends the classification of the first sheet, in S33, the print control unit 132 stores the classification result, that is, the type of the first sheet determined by the classifying unit 131 in the RAM 117. Next, in S35, the print control unit 132 causes the process unit 20 and the fixing unit 60 to start image formation under image formation conditions selected depending on the type of the first sheet. The print control unit 132 causes the registration rollers 26 to resume conveyance of the first sheet. The duration from the temporary pausing to the resumption of the conveyance of the first sheet equals a first duration. When the first sheet passes through the secondary transfer position N_{T}, a toner image is transferred to the first sheet. Further, the first sheet passes through the fixing unit 60 which fixes the toner image to the first sheet.

In S41, the print control unit 132 obtains the result of classification by the classifying unit 131 for the first sheet preceding the second sheet from the RAM 117, for example. Next, in S43, the print control unit 132 causes the process unit 20 and the fixing unit 60 to start image formation under image formation conditions selected depending on the type of the first sheet. The print control unit 132 causes the registration rollers 26 to resume conveyance of the second sheet. The duration from the temporary pausing to the resumption of the conveyance of the second sheet equals a second duration that is shorter than the first duration.

When the second sheet passes through the secondary transfer position N_{T}, a toner image is transferred to the second sheet. Further, the second sheet passes through the fixing unit 60 which fixes the toner image to the second sheet. However, at a point in time before the second sheet passes through the fixing unit 60, the classification of the second sheet by the classifying unit 131 ends. Then, in S45, the print control unit 132 determines whether the type of the second sheet determined by the classifying unit 131 matches the type determined for the preceding first sheet. In a case where the type of the second sheet matches the type of the first sheet, the conveyance control processing proceeds to S47. On the other hand, in a case where the type of the second sheet does not match the type of the first sheet, the conveyance control processing proceeds to S50.

In S47, the print control unit 132 waits for the end of image formation on the first sheet in the case of the first control mode, or on the second sheet in the case of the second control mode. When the image formation ends, the conveyance control processing proceeds to S49. In S49, the print control unit 132 determines whether there remains a next page to be printed in the ongoing image formation job. In a case where there remains a next page to be printed, the conveyance control processing goes back to S23, and S23 to S49 described above are repeated for the next sheet. In a case where printing of all the pages has completed, the conveyance control processing of FIG. 14 ends.

In S50, as an abnormality has been detected for the type of the second sheet, the print control unit 132 performs abnormality processing described next. Then, the conveyance control processing of FIG. 14 ends.

### <6-3. Abnormality Processing>

FIG. 15 is a flowchart showing an example of a more concrete flow of abnormality processing that may be performed in S50 of FIG. 14.

First, in S51, the print control unit 132 stops application of the secondary transfer voltage from the power supply to the secondary transfer roller 9. Next, in S52, the print control unit 132 determines whether the second sheet can be discharged to the escape tray or not. For example, when the discharge tray 71 is the normal discharge destination and the discharge tray 72 is the escape tray, the print control unit 132 may determine, if the leading edge of the second sheet has not reached the branch point to the conveyance path 33 and the conveyance path 36, that discharge to the escape tray is possible. Whether the leading edge of the second sheet has reached the branch point or not may be determined based on a sensor signal from an additional sensor that is disposed near the branch point and detects a leading edge of a sheet, or may be determined based on elapsed time from resumption of conveyance of the second sheet. In a case where it is determined that discharge to the escape tray is possible, the abnormality processing proceeds to S53. On the other hand, in a case where it is determined that discharge to the escape tray is not possible, the abnormality processing proceeds to S55.

In S53, the print control unit 132 causes the second sheet to be discharged to the escape tray through the conveyance path 36 by switching an attitude of a flapper located at the branch point, for example. Next, in S54, the print control unit 132 notifies the user of the abnormality that has been detected for the type of the second sheet. For example, the print control unit 132 causes the abnormality notification screen 181 illustrated in FIG. 11 to be displayed on the display of the operation unit 103 (escape indication).

Meanwhile, in S55, the print control unit 132 interrupts conveyance of the second sheet and image formation. For example, the print control unit 132 causes all of the motors and the rollers in operation to stop. Next, in S56, the print control unit 132 notifies the user of the abnormality that has been detected for the type of the second sheet. For example, the print control unit 132 causes the abnormality notification screen 182 illustrated in FIG. 12 to be displayed on the display of the operation unit 103 (jam indication).

It should be noted that the print control unit 132 may dynamically determine which discharge tray to use as the escape tray. That is, an arbitrary discharge tray other than the normal discharge destination designated in the image formation job may be selected as the escape tray. Alternatively, it is possible to always use a specific discharge tray as the escape tray.

### 7. Summary

Thus far, various embodiments of the technology according to the present disclosure have been described using FIGS. 1 to 15. According to the above-described embodiments, an image forming apparatus measures one or more physical property values for each recording material on which it is to form an image, and classifies the recording material into one of a plurality of types based on the measured physical property values. However, in the first control mode, image formation on a first recording material is started based on the type of the first recording material after the classification of the first recording material has ended and, in the second control mode, image formation on a second recording material is started based on the type of the preceding first recording material before the classification of the second recording material ends. Therefore, even in a case where a highly-accurate classification of a recording material is performed using a learned model, the time to the end of image formation on the second recording material can be shortened and high productivity of the image formation job can be realized.

For example, in the first control mode, the first recording material is conveyed toward the transfer position after the classification of the first recording material has ended. Meanwhile, in the second control mode, the second recording material is conveyed toward the transfer position irrespective of whether the classification of the second recording material has ended or not. Therefore, the duration for which the second recording material pauses before the transfer position is shortened so that the entire job execution time required to execute the image formation job can be shortened.

As an example, the first control mode may be selected for an initial recording material after starting or resuming an image formation job for forming images on a plurality of recording materials, and the second control mode may be selected for recording materials that follow in the same image formation job. In this case, it is possible to shorten the job execution time of an image formation job in which images are formed on two or more sheets. As another example, the first control mode is selected for an initial recording material that is fed from a tray on which an unknown type of recording materials are placed, and the second control mode is selected for recording materials that are subsequently fed from the same tray. In this case, unless an operation to place new sheets on a tray for which a type of recording materials has already been determined is performed, it is possible to shorten a job execution time of a subsequent image formation job in which sheets are fed from the same tray.

According to the above-described embodiments, after the classification of the second recording material has ended and if it is determined that the type of the second recording material is different from the type of the first recording material, abnormality processing is applied to the second recording material for which image formation has already started. Therefore, it is possible to suppress a conveyance failure or deterioration of print quality due to misrecognition of the type of the recording material.

According to the present disclosure, both of highly-accurate classification of recording materials and high productivity can be achieved.

### 8. Other Embodiments

The setting screens set forth in the above-described embodiments may be displayed by any display apparatus. The display apparatus may be, for example, the operation unit 103 connected to the controller 110 of the image forming apparatus 100 or an external apparatus connected via the communication interface 111 and a network. The external apparatus may be, for example, a host computer, or a user terminal such as a personal computer (PC), a smartphone or the like. The display apparatus comprises a display unit (for example, a display), and a display control unit (for example, a CPU) that controls the display unit to display a setting screen that allows a user to set a control mode of the image forming apparatus 100. In particular, a setting screen for accepting a setting regarding to which recording material(s) the first control mode described above is applied (for example, the automatic detection setting screen 160) may be displayed on the display. A setting screen for accepting a setting regarding whether to enable automatic detection of a type of recording materials or not (for example, the tray setting screen 150) may be displayed on a display. A user input to a setting screen may be any form of an input such as, for example, a touch input, an input by a pointing device (e.g. a mouse or the like), a key input, or a speech input. The various embodiment examples related to the first control mode and the second control mode described above are also applicable to a case where a setting for the image forming apparatus 100 is accepted via such a display apparatus.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034032, filed on Mar. 4, 2025, which is hereby incorporated by reference herein in its entirety.

What is claimed is:

1. An image forming apparatus comprising:
a conveyance path along which a recording material is conveyed;
a measuring unit configured to measure one or more physical property values of the recording material on the conveyance path;
a classifying unit configured to classify the recording material into one of a plurality of types by applying the one or more physical property values measured by the measuring unit to a classification model that includes a learned model;
an image forming unit configured to form an image on the recording material based on a type into which the recording material is classified; and
a control unit configured to control image formation on the recording material,
wherein the control unit is configured to:
control, in a first control mode, the image forming unit to start image formation on a first recording material based on a type into which the first recording material is classified after classification of the first recording material by the classifying unit has ended, and
control, in a second control mode, the image forming unit to start image formation on a second recording material based on the type into which the first recording material preceding the second recording material is classified before classification of the second recording material by the classifying unit ends.

2. The image forming apparatus according to claim 1, wherein the measuring unit is disposed at a measurement position that is upstream from a transfer position at which the image forming unit transfers an image to the recording material, and
the control unit is configured to:
in the first control mode, cause the first recording material to be conveyed toward the transfer position after the classification of the first recording material by the classifying unit has ended; and
in the second control mode, cause the second recording material to be conveyed toward the transfer position irrespective of whether the classification of the second recording material by the classifying unit has ended or not.

3. The image forming apparatus according to claim 1, wherein the measuring unit is disposed at a measurement position that is upstream from a transfer position at which the image forming unit transfers an image to the recording material, and
the control unit is configured to:
in the first control mode, cause the first recording material that has arrived at the measurement position to be paused for a first duration and then conveyed toward the transfer position; and
in the second control mode, cause the second recording material that has arrived at the measurement position to be paused for a second duration shorter than the first duration and then conveyed toward the transfer position.

4. The image forming apparatus according to claim 1, wherein
the first recording material is an initial recording material after starting or resuming an image formation job for forming images on a plurality of recording materials, and
the second recording material is a recording material that follows the first recording material in the image formation job.

5. The image forming apparatus according to claim 1, wherein
the first recording material is an initial recording material that is fed from a tray on which an unknown type of recording materials are placed, and
the second recording material is a recording material that is fed from the tray following the first recording material.

6. The image forming apparatus according to claim 1, wherein forming an image based on a type into which the recording material is classified includes forming an image under an image formation condition selected depending on the type into which the recording material is classified.

7. The image forming apparatus according to claim 6, wherein the control unit is configured to determine whether a type of the second recording material classified by the classifying unit matches a type of the first recording material, and to apply abnormality processing for the second recording material in a case where the type of the second recording material is different from the type of the first recording material.

8. The image forming apparatus according to claim 7, wherein the abnormality processing includes stopping conveyance of the second recording material.

9. The image forming apparatus according to claim 7, wherein the abnormality processing includes discharging the second recording material to a second discharge destination that is different from a first discharge destination to which the second recording material would be discharged in a case where the type of the second recording material matches the type of the first recording material.

10. The image forming apparatus according to claim 7, wherein the abnormality processing includes interrupting image formation on the second recording material by the image forming unit.

11. The image forming apparatus according to claim 7, wherein the abnormality processing includes notifying a user of an abnormality for the type of the second recording material.

12. The image forming apparatus according to claim 1, wherein the learned model is a model that has been acquired in advance through machine learning based on samples of a plurality of types of recording materials and known physical property values for the samples.

13. The image forming apparatus according to claim 1, wherein the one or more physical property values include at least one of:
a physical property value related to surface property of a recording material;
a physical property value related to grammage of a recording material;
a physical property value related to thickness of a recording material;
a physical property value related to rigidity level of a recording material;
a physical property value related to volume resistivity of a recording material; and
a physical property value related to moisture content of a recording material.

14. A display apparatus connected to an image forming apparatus configured to classify a recording material into one of a plurality of types by applying one or more physical property values measured for the recording material to a classification model that includes a learned model, start, in a first control mode, image formation on a first recording material based on a type into which the first recording material is classified after classification of the first recording material has ended, and start, in a second control mode, image formation on a second recording material based on the type into which the first recording material preceding the second recording material is classified before classification of the second recording material ends,
the display apparatus comprising a display unit and a display control unit,
wherein the display unit is configured to display a setting screen for accepting a setting regarding to which recording material to apply the first control mode.
